(19) United States
(12) Patent Application Publication
(10) Pub. No.: US 2012/0083346 A1
(43) Pub. Date: Apr. 5, 2012

(54) METHOD AND DEVICE FOR TESTING A WELD JOINT FOR A SHAFT BY MEANS OF A DETECTION DEVICE INTRODUCED THROUGH A PASSAGE OF THE SHAFT; CORRESPONDING ROTOR SHAFT

(76) Inventor: Karl-Heinz Gunzelmann, Nurnberg (DE)

(21) Appl. No.: 13/376,662

(22) PCT Filed: Jun. 9, 2010
(86) PCT No.: PCT/EP10/58095

§ 371 Date: Dec. 7, 2011

(30) Foreign Application Priority Data
Jun. 10, 2009 (DE) 10 2009 024 580.4

(51) Int. Cl. F16C 3/02; B23K 9/16; G01N 3/20; B23K 9/10

(52) U.S. Cl. 464/179; 219/130.33; 219/74; 73/850

(57) ABSTRACT

A method of testing a fusion weld for a shaft includes producing two shaft subsections, wherein the shaft subsections are symmetrical and faun a cylinder coaxially along the axis of rotation. Core regions of each shaft subsection are removed in order to produce open recesses in the cylinder within remaining tubular webs. The two shaft subsections are positioned coaxially one on top of the other, wherein the two remaining webs are mutually adjacent and the two open recesses form a hollow space. A first tubular ring seam is produced by narrow-gap arc welding and in one of the two shaft subsections a passage from outside into the hollow space is produced. Further, a quality of the first tubular ring seam within the hollow space during and/or after the welding operation is evaluated by a detection device or radiation source which is introduced through the passage into the hollow space.

### CROSS REFERENCE TO RELATED APPLICATIONS

This application is the US National Stage of International Application No. PCT/EP2010/058095 filed Jun. 9, 2010, and claims the benefit thereof The International Application claims the benefits of German Patent Application No. 10 2009 024 580.4 DE filed Jun. 10, 2009. All of the applications are incorporated by reference herein in their entirety.

### FIELD OF INVENTION

The present invention relates to a method of testing a fusion weld for a shaft and to a device for testing a fusion welding operation of a shaft.

### BACKGROUND OF INVENTION

During fusion welding of rotor shafts, particularly in the field of turbine and generator construction, narrow-gap arc welding technology is used to assemble forged shaft parts into a complete rotor. An important quality criterion is the formation of a first tubular ring seam, i.e. a so-called first welding bead or root weld, because the dynamic properties of the rotor are crucially influenced by the shape and freedom from defects of this root. The core cross section of the shaft subsection is hollowed out by turning, i.e. the root weld produces a tubular ring seam. In order to inspect this root formation, the weld joints are generally X-rayed over the entire circumference in individual segments and hence the quality is checked. In many cases, after the root welding and after introducing some additional welding beads a second X-ray examination is carried out.

The X-ray examination is effected conventionally in such a way that an X-ray tube on the one side is directed in an axial direction towards the center of the ring. On the opposite side a radiation-sensitive film is disposed, the darkening of which provides information about the seam quality. Depending on a thickness of the root seam and the diameter of the rotor some 8 to 20 segment radiographs at the circumference and, for each radiograph, exposure times of between approx. 4 and 11 minutes are required. Prior to this, the preheating of the rotor from approx. 100° C. to 170° C. that is required for the welding operation has to be reduced, namely to temperatures below 50° C., in order not to damage the film material. Cooling-down and re-heating phases for the final welding of the residual seam take a considerable amount of time, particularly in the case of large rotor masses.

### SUMMARY OF INVENTION

An object of the present invention is, when carrying out narrow-gap arc welding of shaft subsections, in particular of a rotor shaft for a turbine and/or a generator, to improve a quality of a first tubular ring seam, i.e. of a first welding bead or root weld, in a simple and effective manner. The quality of the first tubular ring seam is moreover to be evaluated after and/or during the welding operation.

The object is achieved by a method and by a device as claimed in the claims.

According to a first aspect a method of inspecting a fusion welding operation of a shaft, in particular of a rotor shaft for a turbine and/or a generator, is proposed, which comprises the following steps: Produce at least two shaft subsections, which are symmetrical about an axis of rotation and comprise at least one cylinder coaxially along the axis of rotation and have in each case two main delimiting circular faces perpendicular to the axis of rotation; from the direction of at least one main delimiting circular face remove in each case a core region of in each case one shaft subsection about the axis of rotation in order to produce in each case an open recess in at least one of the cylinders within a remaining tubular web; position in each case two shaft subsections coaxially one on top of the other along the vertical axis of rotation, wherein in each case two webs are mutually adjacent and in each case two recesses forth a hollow space; in other words, a joining of two shaft pieces is effected in a known manner by placing the end faces, which are combined in each case in the form of an annular web, against/into one another. By virtue of the annular webs, the shaft pieces thus joined form a hollow space in the center of the shaft axis; produce a first tubular ring seam for the welded connection of the two webs by means of narrow-gap arc welding wherein, in one of the two shaft subsections a passage is produced from outside into the hollow space. The method is notable for the fact that an evaluation of a quality of the first tubular ring seam is effected from within the hollow space during and/or after the welding operation by means of a detection device or radiation source that is introduced through the passage into the hollow space.

Shaft subsections have in each case two main delimiting circular faces perpendicular to the axis of rotation. These are a bottom surface and a top surface of the shaft subsection, which comprises at least one cylinder positioned coaxially along the axis of rotation. This means that the bottom surface may be the bottom surface of a cylinder of the shaft subsection and the top surface may be the top surface of a further cylinder of the shaft subsection. If the shaft subsection has only one cylinder, then the bottom surface and the top surface are the bottom surface and the top surface of this cylinder. A first tubular ring seam is also referred to as a root weld.

A web is generally a raised area of material.

According to a second aspect a rotor shaft, in particular for a turbine and/or a generator, is manufactured by means of a method as claimed in the invention.

According to a third aspect a detection device or a radiation source for evaluating a quality of a first tubular ring seam from within a hollow space during and/or after the welding operation may be introduced through a passage into the hollow space.

For producing a root weld, in a conventional manner an axial bore of the rotor is used to flush the root interior with shielding gas. This bore may then be used additionally to introduce a detection device or radiation source. It is thereby possible to use the following effects either individually or in combination: Observe the root interior during the welding process; view and assess the root formation after the welding process; it is possible to dispense entirely with an X-ray examination because the seam formation may be evaluated immediately. Costly non-productive periods as a result of temperature changes with cooling-down and reheating of the rotor parts are avoided. The final welding of the seam joint may directly follow inspection.

Further advantageous developments are claimed in conjunction with the sub-claims.

According to an advantageous development the detection device may be an optical detection device. Given use of an optical detection device, it is possible to observe for example a coloring during the welding process and/or a size of the molten material. These sizes may advantageously be used to regulate the welding process.

According to a further advantageous development the optical detection device may be an endoscope or a video camera. Given the use of a video camera, a recording of the video signals for electronic image documentation is available as a quality demonstration record.

According to a further advantageous development the detection device may be a temperature detection device and/or infrared camera. In this way it is possible to use for example a root penetration temperature for metrological evaluation of the root weld. A surface temperature of the first ring seam may moreover be detected and evaluated.

According to a further advantageous development the welding operation may be regulated by means of the detection device during the welding operation on the basis of acquired data. Such data is particularly advantageously a size of the molten material of the ring seam, a coloring of the ring seam, a root penetration temperature or a surface temperature of the weld seam. Root penetration temperature is the temperature of the ring weld seam at the side of the hollow space, since a welding device is positioned from the opposite side.

According to a further advantageous development a power pulse current intensity and/or a voltage may be regulated as welding parameters of a welding device. These are particularly simple options for regulation purposes.

According to a further advantageous development the regulating may be carried out automatically. Equally, an operator of a welding device may regulate the welding operation manually on the basis of a video recording. According to the present invention it is possible to use the following effects either individually or in combination: observe the root interior during the welding process; view and assess the root formation after the welding operation; automatic online regulation of the welding parameters for optimum root formation, for example by means of a metrological evaluation of the root penetration temperature. In this way, by virtue of regulation good quality assurance that is independent of operator control is possible in a particularly advantageous manner.

According to a further advantageous development the radiation source may be an X-ray unit or an isotopic radiator. If the radiation source is an X-ray unit, the quality of the root weld may be effected by X-ray examination from the inside out. For this purpose only one web wall has to be X-rayed. Thus, compared to conventional X-raying less energy is expended for X-raying. There is moreover a marked effective improvement in the quality of the X-ray image.

According to a further advantageous development the passage may be produced by means of drilling along the axis of rotation through the shaft subsection with an open recess, from one side of the open recess.

According to a further advantageous development the passage may alternatively be produced by means of drilling along the axis of rotation through a shaft subsection, from a side without a recess.

According to a further advantageous development the narrow-gap arc welding may be tungsten inert-gas narrow-gap arc welding or gas metal arc welding.

### BRIEF DESCRIPTION OF THE DRAWINGS

The present invention is described in detail with reference to exemplary embodiments in conjunction with the figures, in which

FIG. 1 shows an embodiment of a rotor shaft with a bore and a detection device;

FIG. 2 shows a detailed view of a circle of FIG. 1; and

FIG. 3 shows an embodiment of a method.

### DETAILED DESCRIPTION OF INVENTION

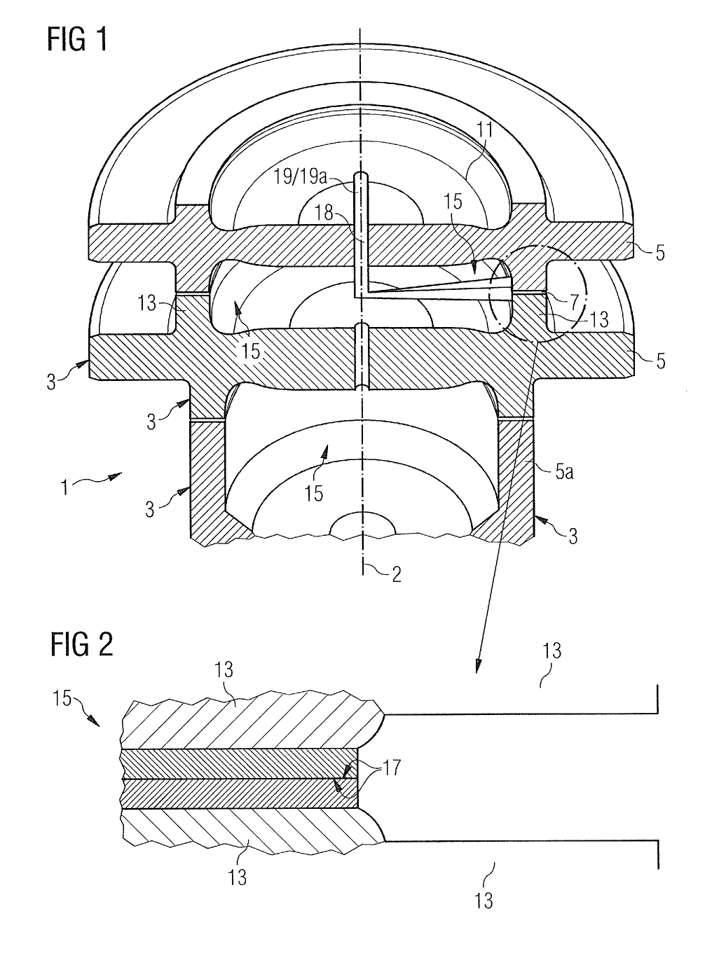

FIG. 1 shows an embodiment of a rotor shaft 1 with a passage 18 and a detection device 19 or a radiation source 19a. In principle, any shafts or axles of an identical style of construction are covered by the present invention. Particular forms of construction are rotor shafts of a turbine and/or a generator.

FIG. 1 shows shaft subsections 5, which have in each case two main delimiting circular faces 7 perpendicular to an axis of rotation 2. The shaft subsections 5 are rotationally symmetrical about the axis of rotation 2 and comprise at least one cylinder 3 positioned coaxially along the axis of rotation 2. Such a cylindrical symmetry is designed to provide an optimum characteristic during revolutions of the rotor shaft 1.

The main delimiting circular faces 7 are therefore bottom and top surfaces of a cylinder 3 or bottom surface and top surface of two different cylinders 3. From at least one main delimiting circular face side in each case a core region of in each case one shaft subsection 5 is removed around the axis of rotation 2. In this way, on at least one main delimiting circular face side of a shaft subsection 5 an open recess 11 is produced. Such an open recess 11 has been produced in at least one of the cylinders 3. Around such an open recess 11 a tubular web 13 remains.

A web 13 is delimited in each case by a remainder of a main delimiting circular face 7. The inside and outside diameters of mutually adjacent webs 13 may be identical. According to an advantageous development the shaft subsections may be forged. Equally, shaft subsection end pieces may be forged.

According to a further advantageous development the removal of the core regions may be effected by turning, in particular by hollowing out by turning. FIG. 1 shows a portion of a rotor shaft 1. What are not shown are any further parts of a finished rotor shaft 1.

The portion of the rotor shaft 1 represented in FIG. 1 is advantageously positioned in such a way that the axis of rotation 2 is vertically aligned. In this way, the shaft subsections 5 may easily be disposed one on top of the other and welded to one another. The complete rotor shaft 1 is produced by welding shaft subsections 5 from above on a shaft end subsection 5a. For this purpose, in each case two shaft subsections 5 and/or 5 and 5a are positioned coaxially on top of one another along the axis of rotation 2. In this case, in each case two webs 13 on the remainders of the associated two main delimiting circular faces 7 are mutually adjacent and in each case two recesses 11 produce a hollow space 15, which is closed.

The circle at the top right of FIG. 1 represents the region of two mutually adjacent webs 13, which is shown enlarged in FIG. 2. In the inner region of the webs 13, a first tubular ring seam 17, which is also referred to as a root weld, is produced by means of narrow-gap arc welding. The two opposing webs 13 are connected to one another by welding and the first tubular ring seam 17 is produced. This is shown enlarged at the bottom of FIG. 2. The first tubular ring seam 17 is in this case situated on a left, inner side of the two webs 13.

Particularly suitable as narrow-gap arc welding is tungsten inert-gas narrow-gap arc welding. Other gas metal arc welding methods are equally possible. By means of a passage 18 produced in one of the two adjacent shaft subsections 5 a shielding gas may be introduced into the hollow space 15. According to FIG. 1 the passage 18 is produced in the uppermost shaft subsection 5 by means of drilling along the axis of rotation 2 from the side of an open recess 11.

FIG. 1 shows a detection device 19 or radiation source 19a that has been introduced from outside through the passage 18 into the hollow space 15. By means of such a detection device 19 or radiation source 19a the quality of the first tubular ring seam 17 may be evaluated from within the hollow space 15 during and/or after the welding operation. In this case the detection device 19 may be an optical detection device. Particularly suitable as an optical detection device is an endoscope or a video camera. In this way the welding operation for producing the first tubular ring seam 17 may be observed and the root interior, i.e. the inside of the first tubular ring seam 17, may be detected during the welding operation. It is further possible to view and assess the first tubular ring seam 17 after the welding operation. By means of optical detection it is possible for example to observe the size of the molten material or a coloring of the molten material.

Furthermore, as an alternative to manual regulation by means of an operator, i.e. a welder, automatic regulation of the welding parameters for optimum embodiment of the first tubular ring seam 17 is possible during the welding operation. For example a root penetration temperature may be evaluated metrologically. By means of the regulation for example on the basis of a temperature measurement a power pulse current intensity of a welding device may be regulated. In this way the quality of the first tubular ring seam 17 may be effectively improved. It is further possible after the welding operation to position a radiation source 19a, for example an X-ray unit or an isotopic radiator, in the hollow space 15. Thus, a conventional X-ray examination of the first tubular ring seam 17 may be effected. X-ray examination from within makes it possible to X-ray merely a portion of a first tubular ring seam 17, which is represented in FIG. 2.

From within, only one wall of two webs 13 that have been welded together has to be X-rayed. In this way a conventional X-ray examination is improved in that less energy is required and the quality of the X-ray images is improved. Welding parameters may be for example likewise a welding voltage of a welding device. A passage 18 may be produced alternatively by means of drilling along the axis of rotation 2 through a shaft part end piece 5a from a side without a recess. This is represented at the bottom of the upper representation in FIG. 1.

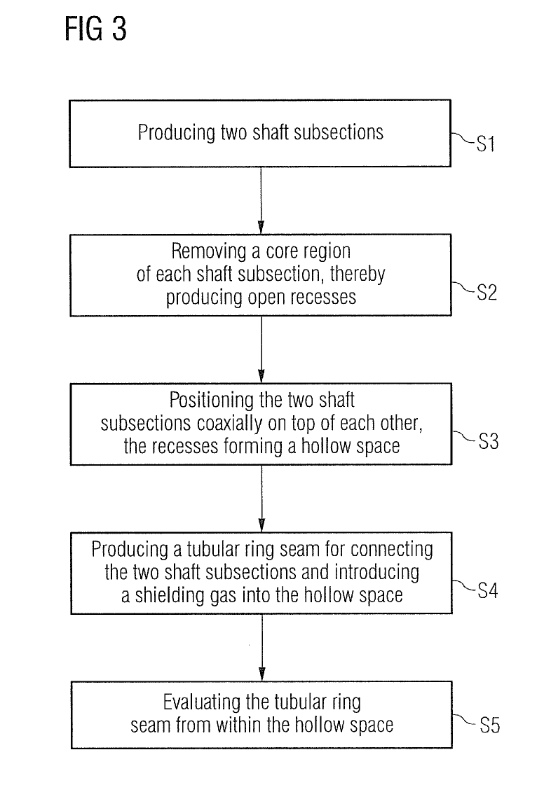

FIG. 3 shows an embodiment of a method. The intention is improved inspection of a fusion welding operation of a shaft, in particular for a turbine and/or a generator. In this case, a step S1 involves producing at least two shaft subsections, which are symmetrical about an axis of rotation and comprise at least one cylinder coaxially along the axis of rotation and have in each case two main delimiting circular faces perpendicular to the axis of rotation. A step S2 involves removing in each case a core region of in each case one shaft subsection around the axis of rotation from at least one main delimiting circular face side in order to produce in each case an open recess in at least one of the cylinders inside a remaining tubular web. This is followed in a next step S3 by positioning in each case two shaft subsections coaxially on top of one another along the vertical axis of rotation, wherein in each case two webs are mutually adjacent and in each case two recesses form a hollow space. A step S4 involves producing a first tubular ring seam for the welded connection of the two webs is effected by means of narrow-gap arc welding, wherein by means of an opening produced in one of the two shaft subsections a shielding gas is introduced into the hollow space. A step S5 involves evaluating a quality of the first tubular ring seam from within the hollow space during and/or after the welding operation by means of a detection device or radiation source that is introduced through the opening into the hollow space.

1-15. (canceled)

16. A method of testing a fusion weld for a shaft, in particular for a turbine and/or a generator, comprising:
producing two shaft subsections, wherein the shaft subsections are symmetrical about an axis of rotation and form a cylinder coaxially along the axis of rotation, and wherein the two shaft subsections comprise two main delimiting circular faces perpendicular to the axis of rotation;
removing, from a direction of one main delimiting circular face, in each case a core region of each shaft subsection about the axis of rotation in order to produce in each case an open recess in the cylinder within a remaining tubular web;
positioning the two shaft subsections coaxially one on top of the other along the axis of rotation, wherein the two remaining webs are mutually adjacent and the two open recesses form a hollow space;
producing a first tubular ring seam for a welded connection of the two webs by narrow-gap arc welding;
producing in one of the two shaft subsections a passage from outside into the hollow space; and
evaluating a quality of the first tubular ring seam from within the hollow space during and/or after the welding operation by a detection device or radiation source which is introduced through the passage into the hollow space.

17. The method as claimed in claim 16, wherein the detection device is an optical detection device.

18. The method as claimed in claim 17, wherein the optical detection device is an endoscope or a video camera.

19. The method as claimed in claim 16, wherein the detection device is an infrared camera.

20. The method as claimed in claim 16, further comprising:
controlling a welding operation based upon acquired data by the detection device during the welding operation.

21. The method as claimed in claim 20, wherein the welding operation is controlled based upon a size of a surface of a melt zone.

22. The method as claimed in claim 20, wherein the welding operation is controlled based upon a root penetration temperature.

23. The method as claimed in claim 20, further comprising:
providing a welding device, wherein a power pulse current intensity and/or a voltage are controlled as welding parameters of the welding device.

24. The method as claimed in claim 20, wherein the controlling is automatically.

25. The method as claimed in claim 16, wherein the radiation source is an X-ray unit or an isotopic radiator.

26. The method as claimed in claim 16, wherein the passage is produced by drilling along the axis of rotation through the shaft subsection via a side of the open recess.

27. The method as claimed in claim 16, wherein the passage is produced by drilling along the axis of rotation through a shaft part end piece via a side without a recess.

28. The method as claimed in claim 16, wherein the narrow-gap arc welding is tungsten inert-gas narrow-gap arc welding or gas metal arc welding.

29. A rotor shaft, in particular for a turbine and/or a generator, wherein the shaft is produced by a method, comprising:
producing two shaft subsections, wherein the shaft subsections are symmetrical about an axis of rotation and form a cylinder coaxially along the axis of rotation, and wherein the two shaft subsections comprise two main delimiting circular faces perpendicular to the axis of rotation;
removing, from a direction of one main delimiting circular face, in each case a core region of each shaft subsection about the axis of rotation in order to produce in each case an open recess in the cylinder within a remaining tubular web;
positioning the two shaft subsections coaxially one on top of the other along the axis of rotation, wherein the two remaining webs are mutually adjacent and the two open recesses form a hollow space;
producing a first tubular ring seam for a welded connection of the two webs by narrow-gap arc welding;
producing in one of the two shaft subsections a passage from outside into the hollow space; and
evaluating a quality of the first tubular ring seam from within the hollow space during and/or after the welding operation by a detection device or radiation source which is introduced through the passage into the hollow space.

30. A device for testing a fusion welding operation of a shaft, in particular for a turbine and/or a generator, comprising:
a camera or an X-ray unit or an isotopic radiator, wherein the camera or the X-ray unit or the isotopic radiator is introduced through a passage into a hollow space of a shaft in order to evaluate a quality of a first tubular ring seam within the hollow space during and/or after a welding operation.
